(19) United States
(12) Patent Application Publication
(10) Pub. No.: US 2025/0237376 A1
(43) Pub. Date: Jul. 24, 2025

(54) Smart Device Screen Perimeter Lighting Device

(71) Applicant: Terin Blanchard, Quincy, IL (US)

(72) Inventor: Terin Blanchard, Quincy, IL (US)

(21) Appl. No.: 19/020,379

(22) Filed: Jan. 14, 2025

Related U.S. Application Data
(60) Provisional application No. 63/622,302, filed on Jan. 18, 2024.

(51) Int. Cl. F21V 33/00; F21S 9/02; F21V 5/00; F21V 21/088; F21V 23/04; F21V 23/06; F21Y 103/10; F21Y 115/10

(52) U.S. Cl. CPC F21V 33/0052; F21S 9/02; F21V 5/002; F21V 21/088; F21V 23/04; F21V 23/06; F21Y 2103/10; F21Y 2115/10

(57) ABSTRACT

A smart device screen perimeter lighting device is provided. The device is designed for use with smart devices such as tablets and laptops, comprising two primary embodiments: a clip-on frame and an integrated bezel lighting system. The clip-on frame embodiment includes a detachable, lightweight frame with adjustable fasteners or snap-fit mechanisms and embedded LED strips, offering customizable brightness and color temperature, powered via USB or an internal battery. This design ensures portability and ease of use across various devices. The integrated bezel embodiment features micro-LED strips seamlessly incorporated into the smart device's bezel, offering similar lighting adjustability controlled via touch-sensitive controls or the device's interface. Both embodiments may include ambient light sensors for adaptive illumination, providing users with optimized lighting for activities like video conferencing, reading, or content creation.

### CROSS-REFERENCE TO RELATED APPLICATION

The present application claims priority to, and the benefit of, U.S. Provisional Application No. 63/622,302, which was filed on Jan. 18, 2024, and is incorporated herein by reference in its entirety.

### FIELD OF THE INVENTION

The present invention relates generally to the field of smart device lighting. More specifically, the present invention relates to a removable case or external attachment for an electronic device, wherein the case comprises 360-degree perimeter lighting around the display for smart devices, comprising a portable clip-on frame with embedded LED strips and an integrated bezel system with micro-LEDs, both offering customizable brightness, color temperature, and adaptive illumination. Accordingly, the present disclosure makes specific reference thereto. Nonetheless, it is to be appreciated that aspects of the present invention are also equally applicable to other like applications, devices, and methods of manufacture.

### BACKGROUND

In the modern era, virtual communication has become a cornerstone of professional and personal interactions, with computer-based meetings increasingly replacing in-person engagements. However, the effectiveness of these virtual interactions often hinges on visual clarity, which can be significantly hampered by inadequate lighting conditions. Poor lighting not only diminishes the quality of video calls but also creates a less engaging experience for participants. The problem is further compounded by the reliance on external lighting solutions, which are often bulky, inconvenient, and difficult to transport. Such devices require additional space and setup time, introducing unnecessary complexity to the user's workspace. Additionally, these external lights are frequently limited in their ability to provide consistent and adjustable illumination tailored to the user's environment. This lack of integration between lighting and the smart device itself leaves users with suboptimal options that detract from the seamless functionality that modern technology aims to provide. The absence of a compact, portable, and integrated lighting solution highlights a critical gap in addressing the needs of remote workers, frequent travelers, and anyone dependent on virtual communication.

Therefore, there exists a long-felt need in the art for a smart device screen perimeter lighting device that provides consistent and high-quality lighting to improve visibility during virtual meetings. There also exists a long-felt need in the art for a smart device screen perimeter lighting device that eliminates the inconvenience and bulkiness associated with external lighting equipment. Moreover, there exists a long-felt need in the art for a smart device screen perimeter lighting device that seamlessly integrates illumination into the frame of smart devices to enhance portability and reduce workspace clutter.

The subject matter disclosed and claimed herein, in one embodiment thereof, comprises a smart device screen perimeter lighting device. The device is designed for use with smart devices such as tablets and laptops, comprising two primary embodiments: a clip-on frame and an integrated bezel lighting system. The clip-on frame embodiment includes a detachable, lightweight frame with adjustable fasteners or snap-fit mechanisms and embedded LED strips, offering customizable brightness and color temperature, powered via USB or an internal battery. This design ensures portability and case of use across various devices. The integrated bezel embodiment features micro-LED strips seamlessly incorporated into the smart device's bezel, offering similar lighting adjustability controlled via touch-sensitive controls or the device's interface. Both embodiments may include ambient light sensors for adaptive illumination, providing users with optimized lighting for activities like video conferencing, reading, or content creation.

In this manner, the smart device screen perimeter lighting device of the present invention accomplishes all the foregoing objectives by embedding an array of LED lights within the outer frame of various smart devices, including computer monitors, smartphones, and tablets. These lights can be easily activated through a built-in button on the device, ensuring immediate and adjustable illumination without the need for additional equipment. By integrating the lighting directly into the device frame, this invention offers a sleek and practical solution that enhances portability and eliminates the clutter associated with standalone lighting systems. The device provides a consistent and efficient source of light, improving the user's on-screen visibility and ensuring a professional appearance during virtual meetings. Furthermore, its compact design ensures that users can enjoy the benefits of high-quality lighting without compromising the aesthetics or functionality of their smart devices.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart device screen perimeter lighting device. The invention is a lighting device for tablets, laptops, and similar smart devices, comprising two embodiments: a clip-on frame and an integrated bezel lighting system. Both embodiments enhance user productivity and comfort by providing optimized illumination for various tasks, such as video conferencing, content creation, reading, and studying.

The clip-on frame embodiment comprises a detachable frame made from lightweight, durable materials, such as reinforced ABS plastic or aluminum alloy, designed to attach securely to one edge of a smart device. Adjustable fasteners lined with silicone-coated materials provide a secure, non-damaging grip. Embedded LED strips, positioned along the top or side edges of the frame, offer customizable brightness and color temperature, ensuring uniform and glare-free illumination via integrated diffuser panels. Power is supplied via a USB port or an internal rechargeable battery. Control is facilitated by physical buttons on the frame, allowing adjustments for power, brightness, and color temperature. The frame's lightweight and portable design makes it suitable for users transitioning between devices or workspaces.

The integrated bezel embodiment incorporates micro-LED strips directly into the smart device's bezel, achieving a slim and seamless design. Diffusion layers ensure even light distribution, while touch-sensitive controls and integration with the smart device's operating system enable convenient adjustments. The lighting system offers customizable brightness and color temperature, maintaining the bezel's aesthetic appeal and preserving device functionality.

Both embodiments may include advanced features like ambient light sensors for automatic brightness and color temperature adjustments, enhancing comfort and usability.

The invention also includes methods for using the device in both embodiments. The clip-on frame method involves securing the frame to the smart device, activating the lighting system, and adjusting its settings via physical controls. The integrated bezel method includes activating and controlling the lighting system through the smart device interface or embedded touch-sensitive controls. Both methods ensure optimal performance across various applications while maintaining a sleek and unobtrusive design.

Accordingly, the smart device screen perimeter lighting device of the present invention is particularly advantageous by embedding an array of LED lights within the outer frame of various smart devices, including computer monitors, smartphones, and tablets. These lights can be easily activated through a built-in button on the device, ensuring immediate and adjustable illumination without the need for additional equipment. By integrating the lighting directly into the device frame, this invention offers a sleek and practical solution that enhances portability and eliminates the clutter associated with standalone lighting systems. The device provides a consistent and efficient source of light, improving the user's on-screen visibility and ensuring a professional appearance during virtual meetings. Furthermore, its compact design ensures that users can enjoy the benefits of high-quality lighting without compromising the aesthetics or functionality of their smart devices. In this manner, the smart device screen perimeter lighting device overcomes the limitations of existing smart device lighting methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of a clip-on embodiment of a smart device screen perimeter lighting device of the present invention in accordance with the disclosed architecture;

FIG. 2 illustrates a front view of a clip-on embodiment of a smart device screen perimeter lighting device of the present invention while attached to a smart device in accordance with the disclosed architecture;

FIG. 3 illustrates a front view of an integrated embodiment of a smart device screen perimeter lighting device of the present invention while integrated into a smart device in accordance with the disclosed architecture;

FIG. 4 illustrates a flowchart of a method of using one potential embodiment of a smart device screen perimeter lighting device of the present invention in accordance with the disclosed architecture; and

FIG. 5 illustrates a flowchart of a method of using one potential embodiment of a smart device screen perimeter lighting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a smart device screen perimeter lighting device that provides consistent and high-quality lighting to improve visibility during virtual meetings. There also exists a long-felt need in the art for a smart device screen perimeter lighting device that eliminates the inconvenience and bulkiness associated with external lighting equipment. Moreover, there exists a long-felt need in the art for a smart device screen perimeter lighting device that seamlessly integrates illumination into the frame of smart devices to enhance portability and reduce workspace clutter.

The present invention, in one exemplary embodiment, is comprised of a smart device screen perimeter lighting device. The invention is a lighting device for tablets, laptops, and similar smart devices, comprising two embodiments: a clip-on frame and an integrated bezel lighting system. Both embodiments improve user productivity and comfort by delivering optimized illumination for tasks such as video conferencing, content creation, reading, and studying.

The clip-on frame embodiment includes a detachable frame constructed from lightweight, durable materials like reinforced ABS plastic or aluminum alloy, designed to attach securely to a smart device edge. Adjustable fasteners with silicone-coated linings ensure a secure grip without causing damage. Embedded LED strips positioned along the top or side edges provide customizable brightness and color temperature, offering uniform and glare-free illumination through integrated diffuser panels. Power is provided via a USB port or an internal rechargeable battery. Physical buttons on the frame enable adjustments to power, brightness, and color temperature. The portable and lightweight frame design makes it suitable for use with multiple devices and workspaces.

The integrated bezel embodiment features micro-LED strips embedded within the bezel of a smart device, creating a slim, seamless design. Diffusion layers provide even light distribution, while touch-sensitive controls and integration with the device's operating system allow for convenient adjustments. The lighting system delivers customizable brightness and color temperature, maintaining the bezel's sleek appearance while preserving device functionality.

Both embodiments may include advanced features such as ambient light sensors to automatically adjust brightness and color temperature based on surrounding conditions, enhancing usability and comfort.

Methods for using the device include securing and activating the clip-on frame or using the integrated bezel lighting system through the device interface or touch-sensitive controls. These methods ensure consistent performance and maintain the device's unobtrusive design.

The invention integrates LED lighting into the perimeter of smart devices, offering a sleek, practical solution that eliminates the need for standalone lighting systems. The design improves on-screen visibility and provides a professional appearance for virtual meetings while preserving the aesthetic and functionality of the smart device. This approach addresses the limitations of existing lighting solutions.

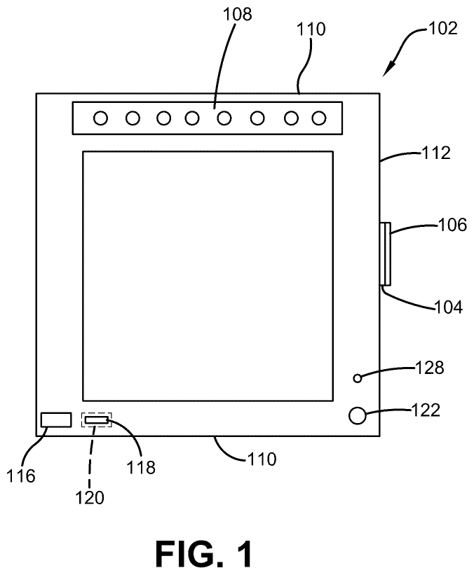

Referring initially to the drawings, FIG. 1 illustrates a front view of a clip-on embodiment of a smart device screen perimeter lighting device 100 of the present invention in accordance with the disclosed architecture. The invention is comprised of a lighting device 100 designed for use with tablets, laptops, and similar smart devices, comprising two primary embodiments: a clip-on frame and an integrated bezel lighting system. Both embodiments are configured to enhance user productivity and comfort by providing optimized illumination for various applications, including video conferencing, content creation, reading, and studying.

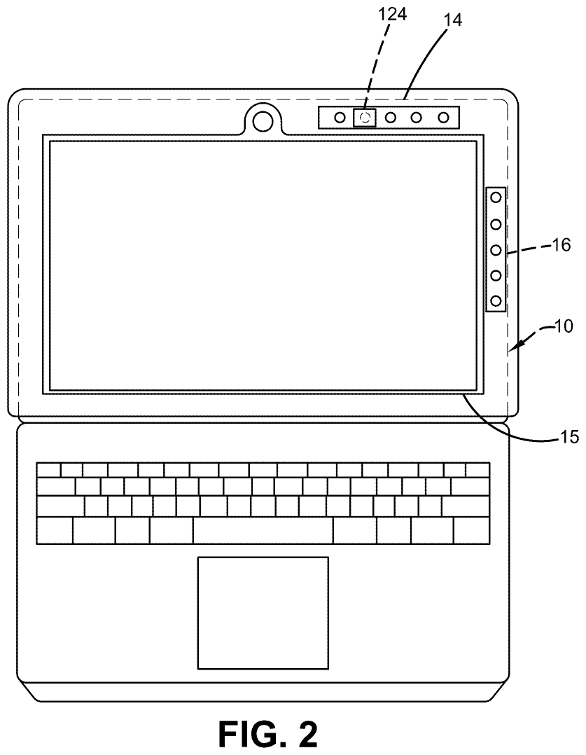

The clip-on frame embodiment of the device 100 is comprised of a detachable and portable lighting solution designed to securely attach to at least one edge of a smart device 10, such as, but not limited to, a tablet, computer, or laptop as seen in FIG. 2. This embodiment includes a detachable frame 102, comprised of lightweight and durable materials, such as reinforced ABS plastic or aluminum alloy. The frame 102 is preferably shaped to contour at least one edge of a tablet or laptop screen. The frame 102 may be comprised of at least one adjustable fastener 104, such as, but not limited to, clamps or clips, ensuring secure attachment to the smart device 10. The fasteners 104 may be lined with non-scratch, silicone-coated materials 106, which provide a soft but firm grip to prevent any damage to the smart device 10 during installation or removal. In one embodiment, the frame 102 snap-fits onto the smart device 10 without the use of fasteners, providing a secure and easily detachable attachment mechanism.

The lighting configuration for the clip-on frame embodiment incorporates at least one embedded LED light 108, preferably in the form of an LED strip with evenly spaced LEDs. The light 108 is preferably positioned along a top edge 110, a bottom edge 111, and/or a side edge 112 of the frame 102. The placement of the LED strip 108 ensures maximum light coverage while maintaining a compact profile. The LEDs 108 may be covered via at least one integrated diffuser panel 114 in one embodiment, which ensures uniform and soft illumination. The diffuser panel 114 is designed to minimize harsh glare and shadowing, resulting in a comfortable and visually consistent lighting effect. The light 108 is capable of emitting light across a range of color temperatures, for example, but not limited to, 2700K to 6500K, accommodating various user preferences and tasks. Additionally, the LEDs 108 offer customizable brightness levels, which can be adjusted to suit specific lighting needs, such as reducing eye strain during extended use.

The clip-on frame embodiment of the device 100 is powered through a USB port 116 or an internal rechargeable lithium-ion battery 118 via a charging port 120, such as, but not limited to, USB-C. The power system is configured for compatibility with a wide range of smart devices 10, making the clip-on frame suitable for diverse environments and applications.

Users can control the LED 108 using at least one physical button 122 located on the frame 102. These buttons 122 are strategically positioned for intuitive access and allow users to adjust the power, brightness, and color temperature of the LED lighting system 108.

The clip-on frame embodiment is designed for portability, featuring a lightweight construction that makes it easy to transfer between multiple smart devices 10. This portability makes the clip-on frame particularly suitable for users who frequently transition between different workspaces or devices, such as remote workers, students, and content creators. The detachable nature of the frame 102 adds to its versatility, offering a convenient and cost-effective lighting solution for a wide range of use cases.

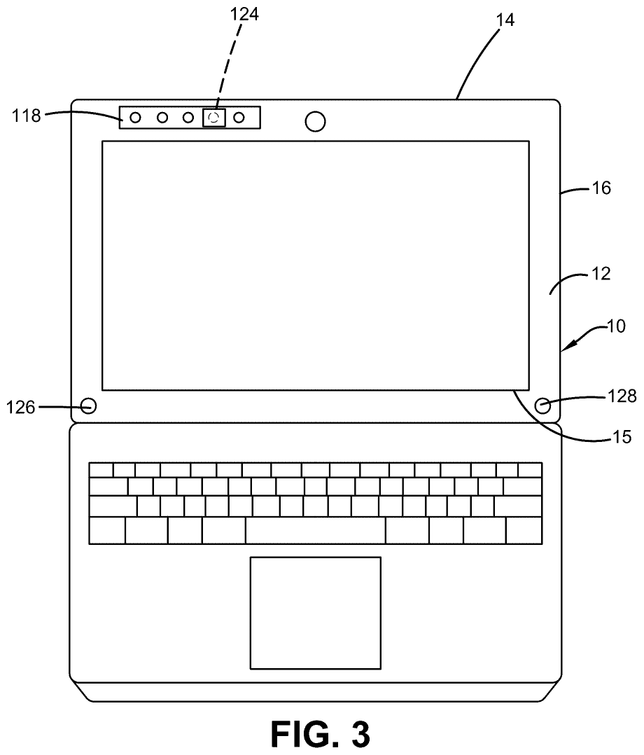

The integrated bezel embodiment of the device 100, as seen in FIG. 3, incorporates the lighting 108 directly into the bezel 12 of a smart device 10. In this embodiment, the bezel 12 is comprised of micro-LED strips 108 embedded along the top edge 14, bottom edge 15, and/or side edge 16 of the device 100. The micro-LED strips 108 are designed for precise integration, allowing for a slim and seamless appearance that aligns with the overall aesthetic of the smart device 10. In one embodiment, integrated diffusion layers 124 positioned above the strips 108 are used to ensure even light distribution. These layers 124 are engineered to diffuse the light emitted by the LEDs 108, creating a uniform and soft illumination effect without adding noticeable bulk to the bezel 12. This approach results in a visually appealing and unobtrusive lighting system that remains discreet when not in use.

The lighting configuration 108 for the integrated bezel embodiment enables adjustable illumination with customizable brightness and color temperature. The micro-LED technology provides consistent lighting performance while preserving the sleek design of the bezel 12. Control of the integrated lighting system 108 is managed through the smart device's 10 operating system interface, allowing users to conveniently adjust lighting settings via on-screen controls. Additionally, touch-sensitive controls 126 may be embedded within the bezel 12 itself, providing users with a tactile and immediate way to adjust lighting 108 intensity and color temperature without navigating through software menus.

The integrated bezel 12 eliminates the need for external attachments, providing a streamlined appearance and a solution tailored specifically to individual devices. This design not only enhances the aesthetic appeal of the smart device 10 but also ensures that the lighting system 108 does not interfere with the device's core functionalities.

Both embodiments of the device 100 may incorporate advanced features, such as ambient light sensors 128 for automatically adjusting the brightness and color temperature of the LED lighting system 108 based on surrounding lighting conditions. These sensors 128 enable adaptive lighting adjustments, providing an optimal illumination level that dynamically adapts to the user's environment, thereby enhancing comfort and usability. In one embodiment, the device 100 is a removable case or external attachment for an electronic device, wherein the case comprises 360-degree perimeter lighting around the display.

By addressing different user preferences and device requirements, the clip-on frame and integrated bezel embodiments provide versatile and practical solutions for improving lighting in a variety of professional and personal applications. The detailed design and functionality of each embodiment ensure that the device 100 meets the diverse needs of modern smart device users.

The present invention is also comprised of a method of using the device 100 in each of its two embodiments: the clip-on frame embodiment and the integrated bezel embodiment. These methods ensure proper setup, operation, and adjustment of the lighting device 100 to optimize its performance for various applications.

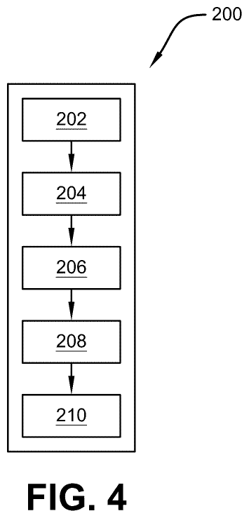

In the clip-on frame embodiment, the method 200 of using the device (as seen in FIG. 4) 100 begins with providing the device 100, which is comprised of a detachable frame 102, at least one LED strip 108, and adjustable fasteners 104 [Step 202]. The user first selects a suitable smart device 10, such as a tablet or laptop, and aligns the frame 102 with the edges of the smart device 10 [Step 204]. Next, the adjustable fasteners 104 are securely attached to the smart device 10 by clamping or snap-fitting the frame 102 in place, ensuring that the silicone-coated materials 106 prevent damage during installation [Step 206]. Once the frame 102 is attached, the lighting configuration 108 can be activated using at least one physical button 122 located on the frame 102, or via a connected mobile application if Bluetooth connectivity is included. The user can adjust the brightness and color temperature of the LEDs 108 as required for the desired application [Step 208]. If the device 100 is powered by an internal battery 118, the user may charge the battery through a USB-C port 116 as needed [Step 210].

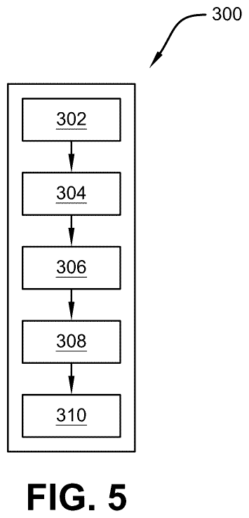

In the integrated bezel embodiment, the method 300 of using the device 100 (as seen in FIG. 5) begins with providing the device 100, which is integrated into the bezel 12 of a smart device 10 and comprised of at least one micro-LED strip 108, integrated diffusion layers 124, and touch-sensitive controls 126 [Step 302]. The user powers on the smart device 10 and accesses the operating system interface to activate the lighting system 108 [Step 304]. The user can adjust the brightness and color temperature of the lighting system 108 through the operating system of the smart device 10 [Step 306]. If the device 100 is equipped with touch-sensitive controls 126 embedded in the bezel 12, the user may directly interact with these controls to make adjustments without the need for software menus [Step 308]. During use, the lighting system 108 provides uniform and customizable illumination, seamlessly integrated into the bezel 12, without requiring any additional attachments or configurations. When the lighting system 108 is no longer needed, the user deactivates it via the operating system interface or the touch-sensitive controls, ensuring that the bezel 12 retains its sleek and unobtrusive appearance [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart device screen perimeter lighting device” and “device” are interchangeable and refer to the smart device screen perimeter lighting device 100 of the present invention.

Notwithstanding the foregoing, the smart device screen perimeter lighting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart device screen perimeter lighting device 100 as shown in the FIGS. are for illustrative purposes only, and that many other sizes and shapes of the smart device screen perimeter lighting device 100 are well within the scope of the present disclosure. Although the dimensions of the smart device screen perimeter lighting device 100 are important design parameters for user convenience, the smart device screen perimeter lighting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart device screen perimeter lighting device comprising:
a detachable frame configured to securely attach to an edge of a smart device;
an embedded LED light positioned on the detachable frame;
a diffuser panel positioned over the embedded LED light, the diffuser panel being configured to distribute illumination uniformly; and
a control mechanism located on the detachable frame, the control mechanism being configured to adjust a power, a brightness, and a color temperature of the embedded LED light.

2. The smart device screen perimeter lighting device of claim 1, wherein the fastener is comprised of a clip or a clamp.

3. The smart device screen perimeter lighting device of claim 2, wherein the fastener is comprised of a silicone-coated material.

4. The smart device screen perimeter lighting device of claim 1, wherein the embedded LED light is positioned along a top edge of the detachable frame.

5. The smart device screen perimeter lighting device of claim 1, wherein the embedded LED light is positioned along a bottom edge of the detachable frame.

6. The smart device screen perimeter lighting device of claim 1, wherein the embedded LED light is positioned along a side edge of the detachable frame.

7. The smart device screen perimeter lighting device of claim 1, wherein the embedded LED light emits a color temperature between 2700K to 6500K.

8. The smart device screen perimeter lighting device of claim 1, wherein the control mechanism is comprised of a button.

9. The smart device screen perimeter lighting device of claim 1 further comprised of a battery.

10. The smart device screen perimeter lighting device of claim 1 further comprised of a USB port.

11. A smart device screen perimeter lighting device comprising:
a bezel integrated into a smart device, the bezel comprising an embedded micro-LED strip;
an integrated diffusion layer positioned over the embedded micro-LED strip, the diffusion layer being configured to distribute illumination uniformly; and
a touch-sensitive control embedded within the bezel, the touch-sensitive control being configured to adjust a power, a brightness, and a color temperature of the embedded micro-LED strip.

12. The smart device screen perimeter lighting device of claim 11, wherein the embedded micro-LED strip can be controlled by a control interface of the smart device.

13. The smart device screen perimeter lighting device of claim 11, wherein the smart device is comprised of a tablet.

14. The smart device screen perimeter lighting device of claim 11, wherein the smart device is comprised of a laptop.

15. The smart device screen perimeter lighting device of claim 11, wherein the smart device is comprised of a computer.

16. The smart device screen perimeter lighting device of claim 11, wherein the embedded micro-LED strip is positioned along a top edge, a bottom edge, or a side edge of the bezel.

17. The smart device screen perimeter lighting device of claim 11 further comprised of an ambient light sensor.

18. The smart device screen perimeter lighting device of claim 17, wherein the ambient light sensor is configured to automatically adjust the brightness and the color temperature of the embedded micro-LED strip based on a surrounding lighting conditions.

19. The smart device screen perimeter lighting device of claim 11, wherein the embedded micro-LED strip emits a color temperature between 2700K to 6500K.

20. A method of using a smart device screen perimeter lighting device, the method comprising the following steps:
providing a smart device screen perimeter lighting device comprised of an LED light, and a diffusion; providing a smart device screen perimeter lighting device in a detachable frame configuration or an integrated bezel configuration;
attaching the detachable frame to an edge of the smart device or activating the integrated bezel lighting system via an operating system interface of the smart device;
powering the smart device screen perimeter lighting device through a power source integrated within the detachable frame or the smart device;
adjusting a brightness and a color temperature of an LED light embedded in the detachable frame or embedded in an integrated bezel using a physical control mechanism on the frame, a touch-sensitive control embedded in the bezel, or a software interface on the smart device; and
utilizing the smart device screen perimeter lighting device to provide uniform illumination for tasks performed on the smart device.
